(19) United States
(12) Patent Application Publication
(10) Pub. No.: US 2026/0011175 A1
(43) Pub. Date: Jan. 8, 2026

(54) IMAGE PROCESSING WITH FACE MASK DETECTION

(71) Applicant: Intel Corporation, Santa Clara, CA (US)

(72) Inventors: Fuwen Li, Beijing (CN); Yu Xia, Beijing (CN); Lan Zhou, Beijing (CN)

(21) Appl. No.: 18/992,105

(22) PCT Filed: Sep. 8, 2022
(86) PCT No.: PCT/CN2022/117834

§ 371 Date: Jan. 7, 2025

(51) Int. Cl. G06V 40/16; G06V 10/44; G06V 10/56

(52) U.S. Cl. CPC G06V 40/165; G06V 10/44; G06V 10/56; G06V 40/171

(57) ABSTRACT

Methods, apparatus, systems, and articles of manufacture are disclosed to automatically process an image based on a detection of a face mask. An example article of manufacture include instructions that, when executed, cause programmable circuitry to at least: map a characteristic of an upper area of a face of a person in an image to a color plot including a face skin tone cone; map a characteristic of a lower area of the face to the color plot; and identify a presence or an absence of a face mask based on the respective positions of the characteristic of the upper area and the characteristic of the lower area relative to the skin tone cone.

### FIELD OF THE DISCLOSURE

This disclosure relates generally to image processing and, more particularly, to image processing with face mask detection.

### BACKGROUND

Image processing techniques including automatic exposure and automatic white balance might be impacted by a face mask, which is usually a different color and brightness than face skin.

### BRIEF DESCRIPTION OF THE DRAWINGS

FIG. 1 is a block diagram of an example image processing system with example face mask detection circuitry.

FIG. 2 is a schematic diagram of an example boundary around an area of a face.

FIG. 3 is a graph of HSV (hue, saturation, value) color space against RGB (red, green, blue) color space including an example skin tone cone.

FIG. 4 is a schematic diagram of an example boundary across the area of the face of FIG. 2.

FIG. 5 is a schematic diagram of the example face of FIG. 2 illustrating a rotation in plane.

FIG. 6 is a schematic diagram of the example face of FIG. 2 illustrating a rotation out of plane.

FIG. 7 is a flowchart representative of example machine readable instructions and/or example operations that may be executed by example processor circuitry to implement the image processing system of FIG. 1.

FIG. 8 is a block diagram of an example processing platform including processor circuitry structured to execute the example machine readable instructions and/or the example operations of FIG. 7 to implement the image processing system of FIG. 1.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Techniques for face detection in images are used for different purposes including, for example, surveillance, security, personal identification, login biometrics, permission to access a location, and/or electronic payment. Face detection is usually the first step for face recognition and/or other related technologies. Face detection also is used in video conferencing such as, for example, with people working from home or studying and attending class from home.

Before images gathered by a camera are processed for face detection, one or more aspects of the images may be adjusted. An example group of adjustments is known as 3A: automatic exposure (AE), automatic white balance (AWB), and automatic focus (AF). Automatic exposure operations adjust image brightness based on an amount of light that reaches the camera sensor (the light exposure). Improper light exposure may lead to a washed out or faded image (overexposure) or a dark image with few details (underexposure). Automatic white balance operations compensate color differences based on lighting so that the color white in an image actually appears white. White objects may appear a different color in an image based on the color temperature of the light that illuminates the object. For example, a white object illuminated by a low color temperature light source will have a reddish tint, and a white object illuminated with a high color temperature light source will have a bluish tint. Automatic focus operations use a sensor, control circuitry, and a motor to adjust a position of a lens to focus on a region of interest. Improper focus can make the region of interest and/or an entire image blurry.

3A adjustments may be specific to faces of one or more people in images. Face-based 3A adjustment capabilities are included with mobile phones, tablets, notebooks, and other electronic devices to improve user experience. With face-based 3A, the face is the region of interest and has higher priority for image processing adjustments compared to background and other areas of the image regardless of the backlight, front light, and/or other conditions captured in the image. Face auto exposure is designed to keep the proper brightness for the face. Face auto white balance is targeted to get natural face skin color for the face instead of adjusting color for the background. Face auto focus uses the face for focus processing and makes sure the face is the clearest part in the scene of the image. However, if user is wearing a face mask, there may be brightness and/or color shifts of the whole image after 3A adjustments because the brightness and color of a mask typically is markedly different than the brightness and color of a face.

At the onset of the COVID-19 pandemic, face masks have become more and more common in daily life. For example, people wearing face masks may join in-person meetings in a conference room that includes a camera to film and/or stream the meeting to other people who join the meeting remotely. However, if people are wearing a face mask, the face-based auto exposure and auto white balance might be impacted by face mask because the face mask has a different color and a different brightness than face skin. In accordance with teachings of this disclosure, a face mask is automatically detected, and the face-based 3A adjustments are modified to account for the presence of the face mask. Thus, image color and brightness abnormalities for face-based 3A adjustments are avoided.

Examples disclosed herein detect a face mask by comparing the difference of average values of hue, saturation, and brightness between an upper half of a face and a lower half of a face in an image. When a face mask is detected, auto exposure and auto white balancing is processed on the portion of the face that is not covered by a face mask. In examples disclosed herein, when a face mask is detected, abnormal brightness and/or color shifting caused by auto exposure and/or auto white balance on the face is avoided because the auto exposure and/or auto white balance is not adjusting the skin of the face based on the color and/or brightness of a face mask. Thus, the skin of the person wearing a face mask appears without color and/or brightness abnormalities.

Examples disclosed herein include many benefits and advantages including, for example, accurately showing the color and brightness of face skin for people wearing face masks in video streaming and/or video conferencing. The example face mask detection mechanisms disclosed here can be easily to integrated into camera systems including, for example, smartphone, tablets, and computers with cameras. In addition, the examples disclosed herein perform image processing with less power consumption compared to prior face mask detection solutions that use heavyweight neutral network/deep learning algorithms involving complicated dataset collecting, labeling, and training processes.

As used herein, an “image” includes still images, digital images, photographs, recorded video, live video, and/or streaming video. An image refers to any visual image gathered by a camera, optical sensor, and/or other type of optical instrument.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

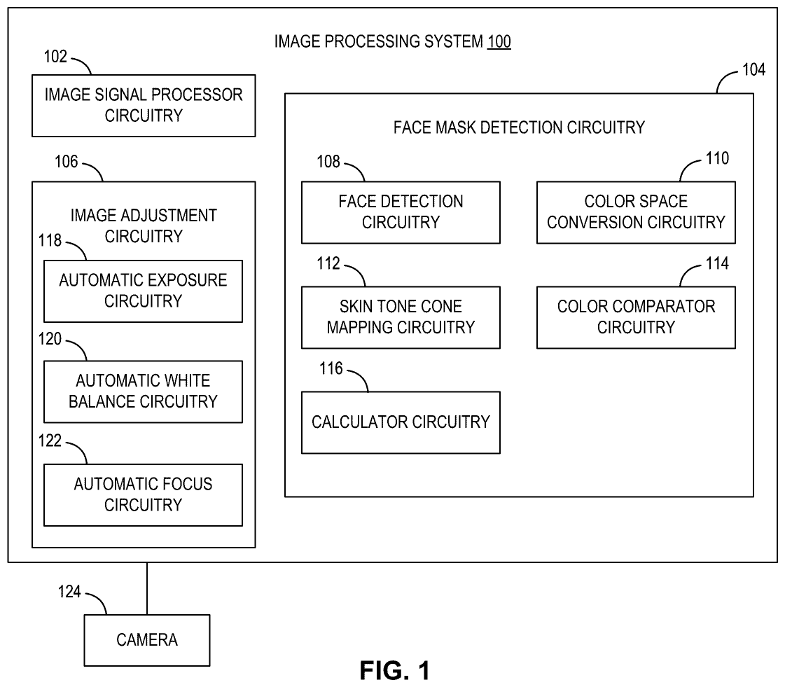

FIG. 1 is a block diagram of an example image processing system 100 that can automatically detect a face mask and modify the image processing including, 3A adjustments, based on the detected face mask. The image processing system 100 includes example image signal processor circuitry 102, example face mask detection circuitry 104, and example image adjustment circuitry 106. The face mask detection circuitry 104 includes, for example, example face detection circuitry 108, example color space conversion circuitry 110, example skin tone cone mapping circuitry 112, example color comparator circuitry 114, and example calculator circuitry 116. The image adjustment circuitry includes, for example, example automatic exposure circuitry 118, example automatic white balance circuitry 120, and example automatic focus circuitry 122.

The image processing system 100 is in communication with an example camera 124 or other optical instrument or optical sensor. In some examples, the image processing system 100 is included within the camera 124. In some examples, the image processing system 100 and the camera 124 are included in the same electronic device. In some examples, the image processing system 100 is remote from the camera 124 and coupled via a wired or wireless connection.

The image processing system 100 accesses, receives, retrieves, or otherwise obtains images from the camera 124. The image signal processor circuitry 102 performs one or more example tasks. In some examples, the image signal processor circuitry 102 performs Bayer transformation by applying a Bayer filter to add colors red, green, and blue (RGB) to the pixels that are recorded in shades of grey by photodiodes of the camera 124. In some examples, the image signal processor circuitry 102 converts to the RGB color space using the YUV color model. The YUV model defines brightness or luminance (Y), blue projection (U), and red projection (V). In such examples, the image signal processor circuitry 102 uses one of a plurality of mapping formulas to convert the YUV data into RGB data. In some examples, the image signal processor circuitry 102 interpolates missing color and brightness information using a demosaicing algorithm. In some examples, the image signal processor circuitry 102 reduces noise in the images. Also, in some examples, the image signal processor circuitry 102 detects edges of objects in the images and sharpens the images. The image signal processor circuitry 102 outputs preprocessed images for further analysis by the image processing system 100.

The face detection circuitry 108 accesses, receives, retrieves, or otherwise obtains the preprocessed images from the image signal processor circuitry 102. In some examples, the face detection circuitry 108 accesses, receives, retrieves, or otherwise obtains raw images directly from the camera 124. In some examples, the face detection circuitry 108 determines face detection data through one or more statistical-based operations including, for example, scale-invariant feature transform (SIFT), Local Binary Pattern (LBP), and/or Discriminative Gaussian Process Latent Variable Model (known as GaussianFace). Also in some examples, the face detection circuitry 108 determines face detection data through a neural network such as, for example, a deep neural network (DNN), a convolutional neural network (CNN), FaceNet, and/or Multi-Task Cascaded Convolutional Neural Networks (MTCNN).

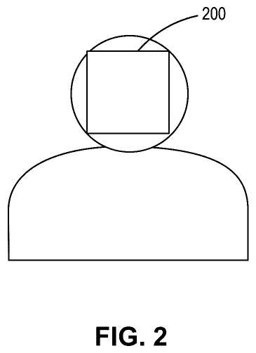

The face detection circuitry 108 outlines an area of a face in an image. For example, the face detection circuitry 108 can draw an outline or boundary such as a rectangle 200 around a face as shown in FIG. 2. In other examples, the outline around the face may be elliptical, circular, and/or another shape. In addition, the face detection circuitry 108 can detect or extract features or landmarks of a face including, for example, eyes, a nose, and a mouth.

The color space conversion circuitry 110 converts the colors of the pixels within the outline 200 around the face from the RGB color space into the HSV color space. The HSV color space represents RGB colors as human vision perceives color characteristics in terms of hue (H), saturation (S), and brightness known as value (V). In the HSV color space, hue, saturation, and value are separate and more distinct than the colors are in the RGB color space. The distinctiveness of hue, saturation, and value facilitates distinguishing between pixels that are face skin pixels that are not face skin (e.g., pixels of a face mask) in accordance with teachings of this disclosure.

Typically, a face mask has a color that is different than the color or tone of face skin. For example, face mask may have a vivid color such as, for example, light blue, light pink, bright white, or dark black. The RGB color space may be converted into the HSV color using, for example, these example equations, where C represents color:

$${R}^{′} = \frac{R}{255}$$

$${G}^{′} = \frac{G}{255}$$

$${B}^{′} = \frac{B}{255}$$

$$C max = max ( {R}^{′} , {G}^{′} , {B}^{′} )$$

$$C min = min ( {R}^{′} , {G}^{′} , {B}^{′} )$$

$$Δ = C max - C min$$

### Hue Calculation:

$$H = \{ \begin{matrix}0 ° , & Δ = 0 \\ 60 ° * ( \frac{{G}^{′} - {B}^{′}}{Δ} + 0 ) , & C max = {R}^{′} \\ 60 ° * ( \frac{{B}^{′} - {R}^{′}}{Δ} + 2 ) , & C max = {G}^{′} \\ 60 ° * ( \frac{{R}^{′} - {G}^{′}}{Δ} + 4 ) , & C max = {B}^{′}\end{matrix}$$

### Saturation Calculation:

$$S = \{ \begin{matrix}0 , & C max = 0 \\ \frac{Δ}{C max} , & C max \neq 0\end{matrix}$$

### Value Calculation:

$$V = C max$$

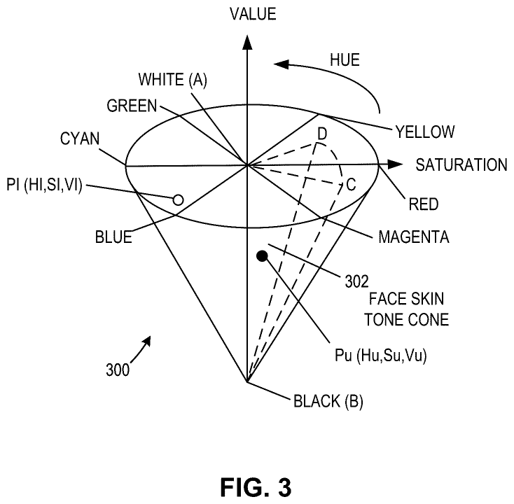

The skin tone cone mapping circuitry 112 defines a skin tone cone. FIG. 3 is a graph of HSV values against a range of RGB values that results in a cone 300. Face skin tone could be diversified from white to dark, but the hue value of face skin tone could not be a color such as, for example, green, cyan, and/or blue. In addition, the saturation of face skin tone cannot be the full space of saturation. Thus, a face skin tone can fall within the portion of the cone 300 marked by points A, B, C and D in FIG. 3. The smaller region within points A, B, C, and D is a face skin tone cone 302 (which is actually a wedge-shaped portion of the cone 300). The face skin tone cone 302 is calibrated based on known data and/or prior experiments. The face skin tone cone 302 is an estimation of full collections for all possible face skin tones, including different races and ethnicities of different people. In some examples, the face skin tone cone 302 could be configurable. The mapped face skin tone cone 302 is used in detection of a face mask as disclosed herein.

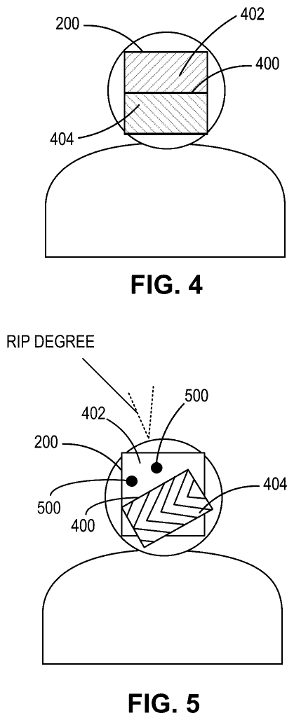

The face detection circuitry 108 analyzes the hue, saturation, and/or brightness/value amounts or figures in the outline 200 to determine if there is a boundary line within the outline 200. A boundary line could be indicative of a face mask. FIG. 4 is a schematic diagram of an example boundary 400 across the area of the face within the outline 200. To obtain an accurate position of the boundary line 400, the hue, saturation, and/or brightness/value averages can be calculated by the calculator circuitry 116 line by line. If there is an abrupt change in the hue, saturation, and/or brightness/value from one line to the next, the boundary line 400 is detected, which may be an upper boundary of a face mask. The face detection circuitry 108 divides the outline 200 area of the face into a face or upper area 402 and a mask or lower area 404.

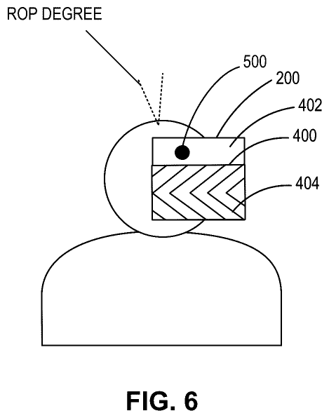

The face detection circuitry 108 can refine the position of the boundary line 400. For example, a person may tilt their head to either side, which is a rotation in plane (RIP), as shown in FIG. 5. The person also may rotate their head to either side, which is a rotation out of plane (ROP), as shown in FIG. 6. The face detection circuitry 108 can determine a more precise and/or the exact mask position by taking the RIP degree and/or the ROP degree into consideration as a person moves.

In addition, the face detection circuitry 108 can determine coordinates of the eyes 500. The face detection circuitry 108 identifies the face mask upper boundary, the boundary line 400, be under the eyes 500.

If the boundary line 400 is not detected, the face detection circuitry 108 divides the area in the outline 200 equally into halves to form the upper area 402 and the lower area 404.

For the upper area 402, the calculator circuitry 116 calculates the average hue (Hu), saturation (Su), and brightness/value (Vu). In addition, for the lower area 404, the calculator circuitry 116 calculates the average hue (Hl), saturation (Sl), and brightness/value (Vl). The calculator circuitry 116 determines the combination of the averages of these metrics as Pu (Hu, Su, Vu) and Pl (Hl, Sl, Vl) to represent average value points of the upper area 402 and the lower half area 404, respectively.

The skin tone cone mapping circuitry 112 maps the upper area average Pu and the lower area average Pl to the cone 300. The color comparator circuitry 114 compares the upper area average Pu and the lower area average Pl to the face skin tone cone 302. There are four combinations about the position of the upper area average Pu and the lower area average Pl with respect to the face skin tone cone 302: (1) both Pu and Pl are inside of the face skin tone cone 302; (2) Pu is inside of the face skin tone cone 302 and Pl is outside of the face skin tone cone 302; (3) Pu is outside of the face skin tone cone 302 and Pl is inside of the face skin tone cone 302; and (4) both Pu and Pl are outside of the face skin tone cone 302. The second combination with Pu inside of the face skin tone cone 302 and Pl outside of the face skin tone cone 302 is illustrated in FIG. 3.

In the first combination, with both Pu and Pl inside of the face skin tone cone 302, further evaluation is needed to determine if there is a face mask. For the further evaluation, the calculator circuitry 116 calculates distance between the upper area average Pu and the lower area average Pl. In some examples, the distance may be calculated by:

$$Distance = \sqrt{{( Hl - Hu )}^{2} + {( Sl - Su )}^{2} + {( Vl - Vu )}^{2}}$$

The distance is the difference between the upper area 402 of the face and the lower area 404 of the face. The color comparator circuitry 114 determines if the distance is larger than a threshold distance. The threshold may be set by prior studies and/or trials with subjects known to be wearing and not wearing face masks. If the color comparator circuitry 114 determines that the distance is larger than the threshold distance, the face mask detection circuitry 104 determines that the person is wearing a face mask. If the color comparator circuitry 114 determines that the distance is not larger than the threshold distance, the face mask detection circuitry 104 determines that the person is not wearing a face mask.

Because face masks typically have different colors and/or brightness than face skin, in other examples, the calculator circuitry 116 determines the distance between the upper area 402 of the face and the lower area 404 of the face by comparing any one of the hue, saturation, and/or brightness/value averages between the upper area 402 of the face and the lower area 404 of the face. The calculator circuitry 116 determines the absolute value of the respective differences of the hue, saturation, and/or brightness/value averages between the upper area 402 of the face and the lower area 404 of the face. Thus, the calculator circuitry 116 may alternatively calculate the distance between the upper area 402 of the face and the lower area 404 of the face by any of one these equations:

$$Distance = \vert ( Hu - Hl ) \vert$$

$$Distance = \vert ( Su - Sl ) \vert$$

$$Distance = \vert ( Vu - Vl ) \vert$$

The calculator circuitry 116 compares those absolute values to respective thresholds for the hue, saturation, and brightness/value. The thresholds may be set by prior studies and/or trials with subjects known to be wearing and not wearing face masks.

$$\vert ( Hu - Hl ) \vert > {TH}_{h}$$

$$\vert ( Su - Sl ) \vert > {TH}_{s}$$

$$\vert ( Vu - Vl ) \vert > {TH}_{v}$$

If the absolute value of the difference for any one of the hue, saturation, and/or brightness/value is larger than the respective threshold THₕ, THₛ, and/or THᵥ, the face mask detection circuitry 104 determines that the person is wearing a face mask. If the absolute value of the difference for all of the hue, saturation, and brightness/value are not larger than the respective threshold THₕ, THₛ, and/or THᵥ, the face mask detection circuitry 104 determines that the person is not wearing a face mask.

In some examples, a person may be wearing a face mask and both Pu and Pl are inside the face skin tone cone 302 because the face mask may a skin tone color. For example, a person with bright skin man may wear a black mask, or a person with dark skin may wear a white mask.

In the second combination noted above, with Pu inside of the face skin tone cone 302 and Pl outside of the face skin tone cone 302, the face mask detection circuitry 104 determines that the person is likely wearing a face mask. The face mask detection circuitry 104 verifies this conclusion by calculating the distance between the upper area 402 and the lower area 404 using one or more examples disclosed herein. If the distance is larger than the threshold, the face mask detection circuitry 104 confirms the person is wearing a mask. If the distance is less than the threshold, the Pu and Pl are too close, and the face mask detection circuitry 104 does not determine that the person is wearing a mask.

In the third combination, with Pu outside of the face skin tone cone 302 and Pl inside of the face skin tone cone 302, the face mask detection circuitry 104 determines that the person is likely not wearing a face mask. The person may be wearing a hat, other head covering, large ski goggles, etc. The face mask detection circuitry 104 verifies this conclusion by calculating the distance between the upper area 402 and the lower area 404 using one or more examples disclosed herein. If the distance is larger than the threshold, the face mask detection circuitry 104 confirms the person is wearing a hat or other object on the upper portion of their head. If the distance is less than the threshold, the Pu and Pl are too close, and the face mask detection circuitry 104 does not make a determination about what the person is wearing.

In the fourth combination, with both Pu and Pl outside of the face skin tone cone 302, the face mask detection circuitry 104 finds the results inconclusive. The face data within the outline 200 might be unreliable. The face data might be unreliable because, for example, the person is moving, there is a bright background, the face data is not updating in a timely manner, etc.

With the information about the presence or absence of a face mask determined, the image adjustment circuitry 106 modifies the image. The automatic focus circuitry focuses the image on the area within the outline 200 whether there is a face mask or not. The operations of the automatic exposure circuitry 118 and the automatic white balance circuitry 120 are adjusted.

When the face mask detection circuitry 108 determines that the person is wearing face mask, the exposed face area (the upper area 402) is processed by the automatic exposure circuitry 118 and the automatic white balance circuitry 120 in accordance with automatic exposure and automatic white balance protocols. The face mask area (the lower area 404) is not processed by the automatic exposure circuitry 118 and the automatic white balance circuitry 120. The lower area 404 is not auto exposure processed when there is a face mask worn by the person because processing the face mask area with automatic exposure when the face mask is brighter than the face skin will result in an image that is too dark, and processing the face mask area with automatic exposure when the face mask is less bright than the face skin will result in an image that is too bright. Images that are too dark or too bright are not acceptable and are not expected by users (e.g., people in a video conference). In addition, the lower area 404 is not auto white balance processed when there is a face mark worn by the person because processing the face mask area with automatic white balancing will result in a color shift, which also is not acceptable or expected. In some examples, if a person has a heavy and/or dark beard, the bearded area is not auto exposure or auto white balanced processed in the same manner and for the same reasons as the presence of a face mask.

When the face mask detection circuitry 108 determines that the person is not wearing face mask, the entire area in the outline 200 (both the upper area 402 and the lower area 404) are processed by the automatic exposure circuitry 118 and the automatic white balance circuitry 120 in accordance with automatic exposure and automatic white balance protocols.

FIG. 1 is a block diagram of the image processing system 100 to process images based on face mask detection. The image processing system 100 of FIG. 1 may be instantiated (e.g., creating an instance of, bring into being for any length of time, materialize, implement, etc.) by processor circuitry such as a central processing unit executing instructions. Additionally or alternatively, the image processing system 100 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

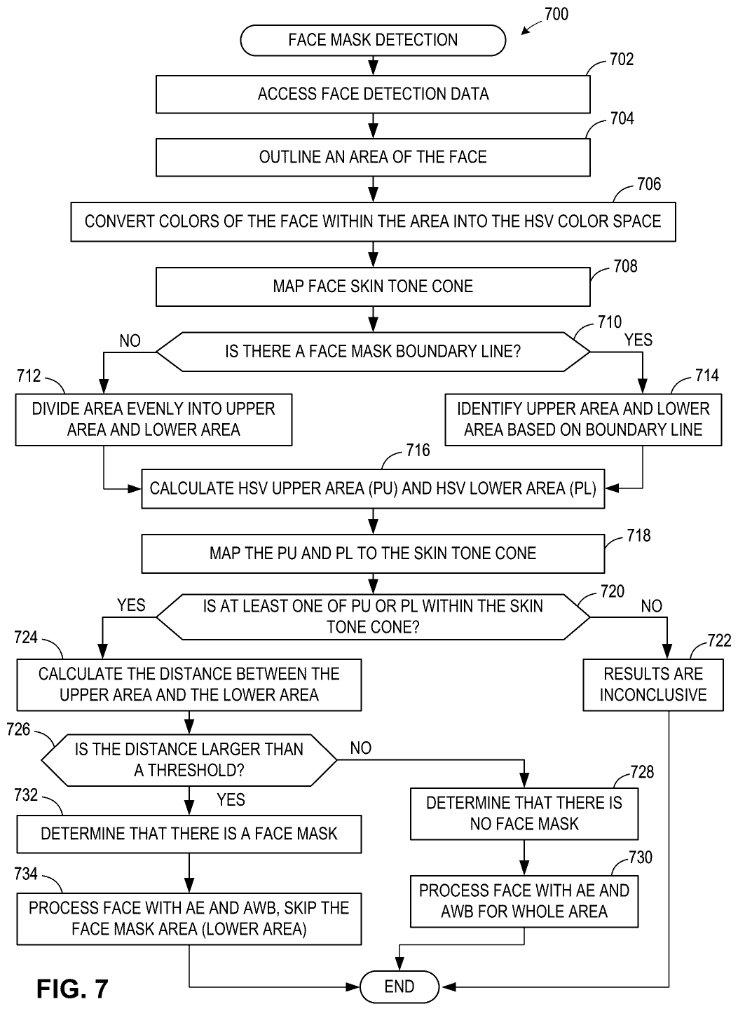

In some examples, the face detection circuitry 108 of the face mask detection circuitry 104 is instantiated by processor circuitry executing face detection instructions and/or configured to perform operations such as those represented by the flowchart of FIG. 7. In some examples, the color space conversion circuitry 110 of the face mask detection circuitry 104 is instantiated by processor circuitry executing color space conversion instructions and/or configured to perform operations such as those represented by the flowchart of FIG. 7. In some examples, the skin tone cone mapping circuitry 112 of the face mask detection circuitry 104 is instantiated by processor circuitry executing skin tone cone mapping instructions and/or configured to perform operations such as those represented by the flowchart of FIG. 7. In some examples, the color comparator circuitry 114 of the face mask detection circuitry 104 is instantiated by processor circuitry executing color comparison instructions and/or configured to perform operations such as those represented by the flowchart of FIG. 7. In some examples, the calculator circuitry 116 of the face mask detection circuitry 104 is instantiated by processor circuitry executing calculation instructions and/or configured to perform operations such as those represented by the flowchart of FIG. 7.

In some examples, the automatic exposure circuitry 118 of the image adjustment circuitry 106 is instantiated by processor circuitry executing automatic exposure instructions and/or configured to perform operations such as those represented by the flowchart of FIG. 7. In some examples, the automatic white balance circuitry 120 of the image adjustment circuitry 106 is instantiated by processor circuitry executing automatic white balancing instructions and/or configured to perform operations such as those represented by the flowchart of FIG. 7. In some examples, the automatic focus circuitry 122 of the image adjustment circuitry 106 is instantiated by processor circuitry executing automatic focus instructions and/or configured to perform operations such as those represented by the flowchart of FIG. 7.

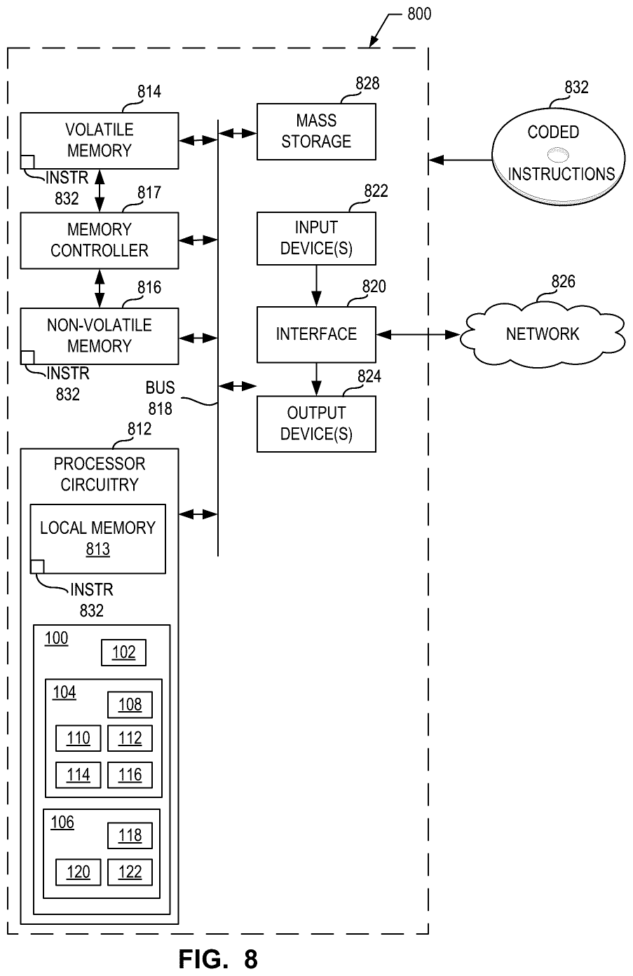

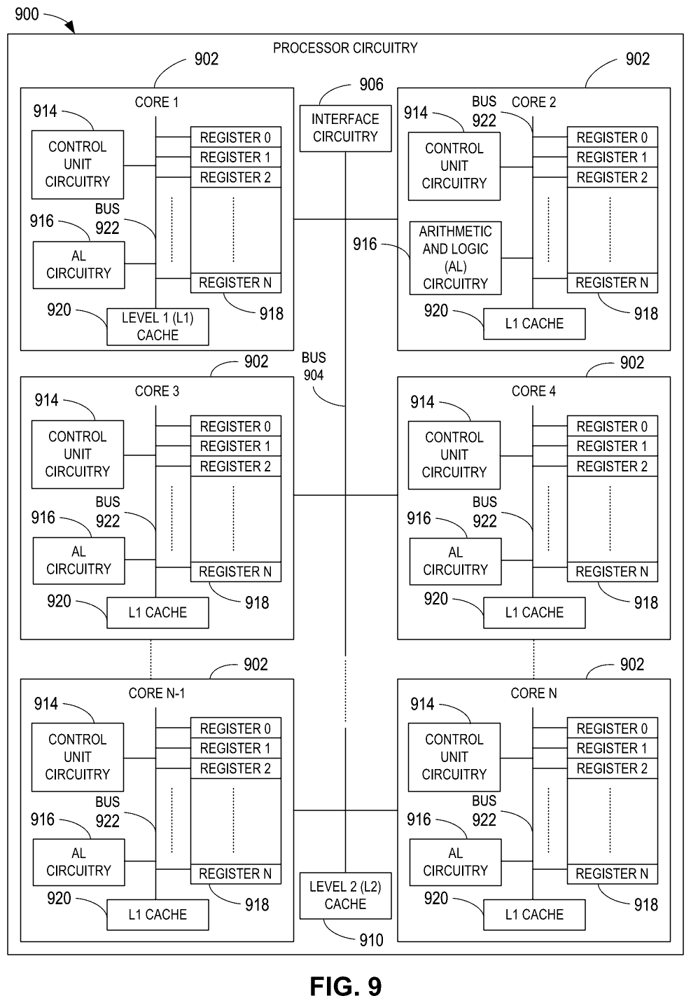

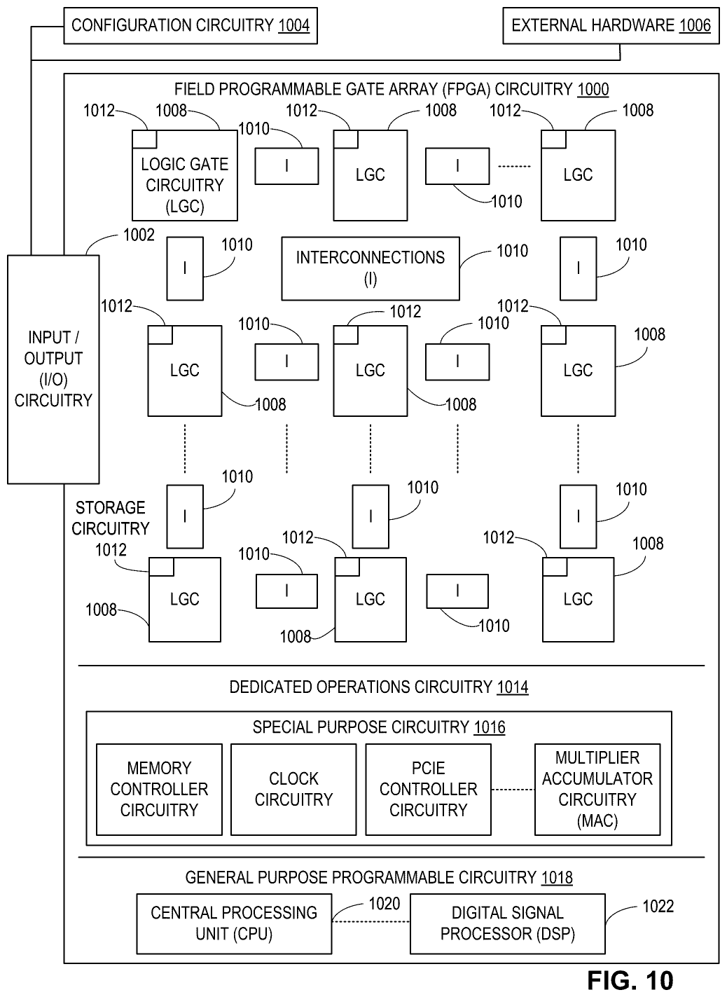

In some examples, the apparatus includes means for detecting a face mask. For example, the means for detecting may be implemented by the face mask detection circuitry 104. In some examples, the face mask detection circuitry 104 may be instantiated by processor circuitry such as the example processor circuitry 812 of FIG. 8. For instance, the face mask detection circuitry 104 may be instantiated by the example microprocessor 900 of FIG. 9 executing machine executable instructions such as those implemented by at least blocks 702-728 and 732 of FIG. 7. In some examples, the face mask detection circuitry 104 may be instantiated by hardware logic circuitry, which may be implemented by an ASIC, XPU, or the FPGA circuitry 1000 of FIG. 10 structured to perform operations corresponding to the machine readable instructions. Additionally or alternatively, the face mask detection circuitry 104 may be instantiated by any other combination of hardware, software, and/or firmware. For example, the face mask detection circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for adjusting an image. For example, the means for adjusting may be implemented by the image adjustment circuitry 106. In some examples, the image adjustment circuitry 106 may be instantiated by processor circuitry such as the example processor circuitry 812 of FIG. 8. For instance, the image adjustment circuitry 106 may be instantiated by the example microprocessor 900 of FIG. 9 executing machine executable instructions such as those implemented by at least blocks 730 and 734 of FIG. 7. In some examples, the image adjustment circuitry 106 may be instantiated by hardware logic circuitry, which may be implemented by an ASIC, XPU, or the FPGA circuitry 1000 of FIG. 10 structured to perform operations corresponding to the machine readable instructions. Additionally or alternatively, the image adjustment circuitry 106 may be instantiated by any other combination of hardware, software, and/or firmware. For example, the image adjustment circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the image processing system 100 is illustrated in FIG. 1, one or more of the elements, processes, and/or devices illustrated in FIG. 1 may be combined, divided, re-arranged, omitted, eliminated, and/or implemented in any other way. Further, the example image signal processor circuitry 102, the example face mask detection circuitry 104, the example image adjustment circuitry 106, the example face detection circuitry 108, the example color space conversion circuitry 110, the example skin tone cone mapping circuitry 112, the example color comparator circuitry 114, the example calculator circuitry 116, the example automatic exposure circuitry 118, the example automatic white balance circuitry 120, the example automatic focus circuitry 122, and/or, more generally, the example image processing system 100 of FIG. 1, may be implemented by hardware alone or by hardware in combination with software and/or firmware. Thus, for example, any of the example image signal processor circuitry 102, the example face mask detection circuitry 104, the example image adjustment circuitry 106, the example face detection circuitry 108, the example color space conversion circuitry 110, the example skin tone cone mapping circuitry 112, the example color comparator circuitry 114, the example calculator circuitry 116, the example automatic exposure circuitry 118, the example automatic white balance circuitry 120, the example automatic focus circuitry 122, and/or, more generally, the example image processing system 100 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example image processing system 100 of FIG. 1 may include one or more elements, processes, and/or devices in addition to, or instead of, those illustrated in FIG. 1, and/or may include more than one of any or all of the illustrated elements, processes and devices.

A flowchart representative of example machine readable instructions, which may be executed to configure processor circuitry to implement the image processing system 100 of FIG. 1, is shown in FIG. 7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 7, many other methods of implementing the example image processing system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to detect a face mask in an image. The machine readable instructions and/or the operations 700 of FIG. 7 include the face detection circuitry 108 accessing face detection data (block 702). The face detection circuitry 108 outlines an area of the face (block 704).

The color space conversion circuitry 110 converts color of the face (RGB colors of the pixels of the face) within the area of the outline into the HSV color space (block 706). The skin tone cone mapping circuitry 112 maps a face skin tone cone such as, for example, the plot shown in FIG. 3 (block 708).

The face detection circuitry 108 determines if there is a boundary line across the area of the face within the outline (block 710). If there is no boundary line (block 710: NO), the face detection circuitry 108 divides the area of the face in the outline evenly into an upper area and a lower area (block 712). If there is a boundary line (block 710: YES), the face detection circuitry 108 identifies the upper area and the lower area of the face within the outline based on the boundary line (block 714). In some examples, the face detection circuitry 108 corroborates and/or refines the position of the boundary line using one or more of eye coordinate position, RIP degree data, and/or ROP degree data as disclosed herein.

After the face detection circuitry 108 has created and/or identified the upper area and the lower area of the face, the calculator circuitry 116 determines the average hue, saturation, and brightness/value across a plurality of pixels in each of the upper area and the lower area of the face and aggregates or combines the metrics into an HSV combination for the upper area (Pu) and an HSV combination for the lower area (Pl) (block 716).

The skin tone cone mapping circuitry 112 maps the Pu and the Pl to the skin tone cone (block 718). The color comparator circuitry 114 compares the respective positions of the Pu and Pl to the skin tone cone to determine if at least one of the Pu or the Pl is within the skin tone cone (block 720). If neither the Pu nor the Pl are within the skin tone cone (block 720: NO), the face mask detection circuitry 104 determines that the results are inconclusive (block 722). In other words, the face mask detection circuitry 104 does not determine if a person in an image is wearing a face mask or not.

If at least one of the Pu or the Pl are within the skin tone cone (block 720: YES), there may be a face mask in the image, and the face mask detection circuitry 104 verifies the result through the distance calculation. Specifically, in some examples, the calculator circuitry 116 calculates the distance between the upper area and the lower area (block 724). The distance between the upper area and the lower area is a comparison of one or more of the hue, saturation, and/or brightness/value of the upper area and the lower area. The distance may be calculated using, for example, one or more of the equations disclosed above.

The face detection circuitry 108 determines if the distance is larger than a threshold (block 726). If the distance is not larger than the threshold (block 726: NO), the face detection circuitry 108 determines that the person in the image is not wearing a face mask (block 728). If the person is not wearing a face mask, the image adjustment circuitry 106 processes the whole face area of the image. For example, the automatic exposure circuitry 118 adjusts exposure of the whole face area and the automatic white balance circuitry 120 adjusts the white balance of the whole face area (block 730).

If the distance is larger than the threshold (block 726: YES), the face detection circuitry 108 determines that the person in the image is wearing a face mask (block 732). If the person is wearing a face mask, the image adjustment circuitry 106 processes only the upper area of the face of the image. For example, the automatic exposure circuitry 118 adjusts exposure of the upper face area and the automatic white balance circuitry 120 adjusts the white balance of the upper face area and the lower area is skipped (block 734). The automatic exposure circuitry 118 and the automatic white balance circuitry 120 process the upper area and not the lower area so that the skin of the upper area is appropriately adjusted and the colors and brightness are not distorted by auto exposure and auto white balancing of the face mask.

FIG. 8 is a block diagram of an example processor platform 800 structured to execute and/or instantiate the machine readable instructions and/or the operations of FIG. 7 to implement the image processing system 100 of FIG. 1. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example image processing system 100, the example image signal processor circuitry 102, the example face mask detection circuitry 104, the example image adjustment circuitry 106, the example face detection circuitry 108, the example color space conversion circuitry 110, the example skin tone cone mapping circuitry 112, the example color comparator circuitry 114, the example calculator circuitry 116, the example automatic exposure circuitry 118, the example automatic white balance circuitry 120, and the example automatic focus circuitry 122.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 832, which may be implemented by the machine readable instructions of FIG. 7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowchart of FIG. 7 to effectively instantiate the circuitry of FIG. 1 as logic circuits to perform the operations corresponding to those machine readable instructions. In some such examples, the circuitry of FIG. 1 is instantiated by the hardware circuits of the microprocessor 900 in combination with the instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 5 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowchart of FIG. 7. As such, the FPGA circuitry 1000 may be structured to effectively instantiate some or all of the machine readable instructions of the flowchart of FIG. 7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIG. 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 6, includes example input/output (I/O) circuitry 1002 to obtain and/or output data to/from example configuration circuitry 1004 and/or external hardware 1006. For example, the configuration circuitry 1004 may be implemented by interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may be implemented by external hardware circuitry. For example, the external hardware 1006 may be implemented by the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations that may correspond to at least some of the machine readable instructions of FIG. 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowchart of FIG. 7 may be executed by one or more of the cores 902 of FIG. 9, a second portion of the machine readable instructions represented by the flowchart of FIG. 7 may be executed by the FPGA circuitry 1000 of FIG. 10, and/or a third portion of the machine readable instructions represented by the flowchart of FIG. 7 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 812 of FIG. 8 may be in one or more packages. For example, the microprocessor 900 of FIG. 9 and/or the FPGA circuitry 1000 of FIG. 106 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

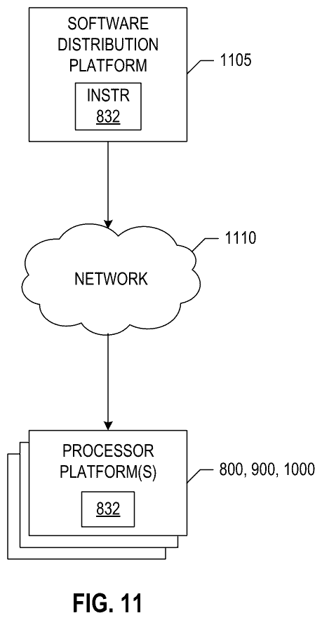

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 700 of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 700 of FIG. 7, may be downloaded to the example processor platform 800, which is to execute the machine readable instructions 832 to implement the image processing system 100. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that automatically process images based on the presence or absence of a face mask to produce images that have proper color and brightness of the skin of the faces of people wearing face masks. Improper color shifting and brightness levels produced by conventional image processing that do not account for the presence of a face mask are avoided. In addition, the large processing bandwidth and other resources that are consumed by techniques relying solely on neural networks are not required with the examples disclosed here. Thus, the disclosed systems, methods, apparatus, and articles of manufacture improve the efficiency of using a computing device, and the disclosed systems, methods, apparatus, and articles of manufacture are accordingly directed to one or more improvement(s) in the operation of a machine such as a computer or other electronic and/or mechanical device.

Example methods, apparatus, systems, and articles of manufacture are disclosed to automatically process an image based on a detection of a face mask. Example 1 includes an apparatus that includes: at least one memory; machine readable instructions; and processor circuitry to at least one of instantiate or execute the machine readable instructions to: determine a characteristic of an upper area of a face of a person in an image; determine a characteristic of a lower area of the face of the person; calculate a distance between the characteristic of the upper area and the characteristic of the lower area; compare the distance to a threshold; and identify a presence of a face mask when the distance is greater than the threshold.
Example 2 includes the apparatus of Example 1, wherein the characteristic is at least one of a hue, a saturation, or a value.
Example 3 includes the apparatus of Examples 1 and/or 2, wherein the processor circuitry is to: convert RGB color space of the image into HSV color space; and determine the characteristic of the upper area and the characteristic of the lower area based on the HSV color space.
Example 4 includes the apparatus of any of Examples 1-3, wherein the characteristic of the upper area is at least one of an average of a hue across the upper area, an average of a saturation across the upper area, or an average of a value across the upper area, and wherein the characteristic of the lower area is at least one of an average of a hue across the lower area, an average of a saturation across the lower area, or an average of a value across the lower area.
Example 5 includes the apparatus of any of Examples 1-4, wherein the characteristic of the upper area is based on an average of a hue across the upper area, an average of a saturation across the upper area, and an average of a value across the upper area, and wherein the characteristic of the lower area is based on an average of a hue across the lower area, an average of a saturation across the lower area, and an average of a value across the lower area.
Example 6 includes the apparatus of any of Examples 1-5, wherein the processor circuitry is to process the upper area with automatic exposure and skip the lower area when the face mask is identified.
Example 7 includes the apparatus of any of Examples 1-6, wherein the processor circuitry is to process the upper area with automatic white balance and skip the lower area when the face mask is identified.
Example 8 includes the apparatus of any of Examples 1-7, wherein the processor circuitry is to: identify a boundary line on the face of the person; and divide the face into the upper area and the lower area based on the boundary line.
Example 9 includes an apparatus that includes: at least one memory;
machine readable instructions; and processor circuitry to at least one of instantiate or execute the machine readable instructions to: determine a characteristic of an upper area of a face of a person in an image; determine a characteristic of a lower area of the face of the person; map the characteristic of the upper area and the characteristic of the lower area to a color plot including a face skin tone cone; and identify a presence of a face mask when the characteristic of the upper area is within the face skin tone cone and the characteristic of the lower area is not within the skin tone cone.
Example 10 includes the apparatus of Example 9, wherein the characteristic is at least one of a hue, a saturation, or a value.
Example 11 includes the apparatus of Examples 9 and/or 10, wherein the processor circuitry is to: convert RGB color space of the image into HSV color space; and determine the characteristic of the upper area and the characteristic of the lower area based on the HSV color space.
Example 12 includes the apparatus of any of Examples 9-11, wherein the characteristic of the upper area is based on an average of a hue across the upper area, an average of a saturation across the upper area, and an average of a value across the upper area, and wherein the characteristic of the lower area is based on an average of a hue across the lower area, an average of a saturation across the lower area, and an average of a value across the lower area.
Example 13 includes the apparatus of any of Examples 9-12, wherein the processor circuitry is to avoid the lower area and process the upper area with automatic exposure when the face mask is identified.
Example 14 includes the apparatus of any of Examples 9-13, wherein the processor circuitry is to avoid the lower area and process the upper area with automatic white balance when the face mask is identified.
Example 15 includes the apparatus of any of Examples 9-14, wherein the processor circuitry is to: determine a distance between the characteristic of the upper area and the characteristic of the lower area; and verify the presence of the face mask based on the distance.
Example 16 includes a non-transitory machine readable storage medium that includes instructions that, when executed, cause programmable circuitry to at least: map a characteristic of an upper area of a face of a person in an image to a color plot including a face skin tone cone; map a characteristic of a lower area of the face to the color plot; and identify a presence or an absence of a face mask based on the respective positions of the characteristic of the upper area and the characteristic of the lower area relative to the face skin tone cone.
Example 17 includes the storage medium of Example 16, wherein the instructions cause the programmable circuitry to determine a position of a boundary between the upper area and the lower area.
Example 18 includes the storage medium of Examples 16 and/or 17, wherein the instructions cause the programmable circuitry to: convert RGB color space of pixels in the image into HSV color space; and determine the characteristic of the upper area and the characteristic of the lower area based on the HSV color space.
Example 19 includes the storage medium of any of Examples 16-18, wherein the instructions cause the programmable circuitry to: determine the characteristic of the upper area by aggregating an average hue, an average saturation, and an average value of a plurality of pixels in the upper area; and determine the characteristic of the lower area by aggregating an average hue, an average saturation, and an average value of a plurality of pixels in the lower area.
Example 20 includes the storage medium of any of Examples 16-19, wherein the instructions cause the programmable circuitry to identify the presence of the face mask when the characteristic of the upper area is within the face skin tone cone and the characteristic of the lower area is not within the skin tone cone.
Example 21 includes the storage medium of any of Examples 16-20, wherein the instructions cause the programmable circuitry to identify the absence of the face mask when the characteristic of the upper area is not within the face skin tone cone.
Example 22 includes the storage medium of any of Examples 16-21, wherein the instructions cause the programmable circuitry to: calculate a distance between the characteristic of the upper area and the characteristic of the lower area; and verify the presence or the absence of the face mask based on the distance.
Example 23 includes the storage medium of any of Examples 16-22, wherein the instructions cause the programmable circuitry to: compare the distance to a threshold distance; and verify the presence of the face mask when the distance is greater than the threshold.
Example 24 includes a method of processing images based on detection of a face mask, the method including: identifying, by executing instructions with a processor, an upper area of a face and a lower area of a face; calculating, by executing instructions with the processor: an average hue (Hu), an average saturation (Su), and an average value (Vu) for the upper area; an average hue (Hl), an average saturation (Sl), and an average value (Vl) for the lower area; an HSV combination for the upper area: Pu (Hu, Su, Vu); and an HSV combination for the lower area: Pl (Hl, Sl, Vl); mapping, by executing instructions with the processor, the Pu and the Pl to a plot including a face skin tone cone; and identifying, by executing instructions with the processor, a presence of an absence of the face mask based on a respective position of the Pu on the map and the Pl on the map relative to the face skin tone cone.
Example 25 includes the method of Example 24, further including: identifying, by executing instructions with the processor, the presence of the face mask when the Pu is within the face skin tone cone and the Pl is not within the skin tone cone; or identifying, by executing instructions with the processor, the presence of the face mask when (a) the Pu is within the face skin tone cone, (b) the Pl is within the face skin tone cone, and (c) a calculated distance between one or more of the Hu, Su, Vu and one or more respective Hl, Sl, Vl is greater than a threshold distance.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to at least one of instantiate or execute the machine readable instructions to:
determine a characteristic of an upper area of a face of a person in an image;
determine a characteristic of a lower area of the face of the person;
calculate a distance between the characteristic of the upper area and the characteristic of the lower area;
compare the distance to a threshold; and
identify a presence of a face mask when the distance is greater than the threshold.

2. The apparatus of claim 1, wherein the characteristic is at least one of a hue, a saturation, or a value.

3. The apparatus of claim 2, wherein the processor circuitry is to:
convert RGB color space of the image into HSV color space; and
determine the characteristic of the upper area and the characteristic of the lower area based on the HSV color space.

4. The apparatus of claim 1, wherein the characteristic of the upper area is at least one of an average of a hue across the upper area, an average of a saturation across the upper area, or an average of a value across the upper area, and wherein the characteristic of the lower area is at least one of an average of a hue across the lower area, an average of a saturation across the lower area, or an average of a value across the lower area.

5. The apparatus of claim 1, wherein the characteristic of the upper area is based on an average of a hue across the upper area, an average of a saturation across the upper area, and an average of a value across the upper area, and wherein the characteristic of the lower area is based on an average of a hue across the lower area, an average of a saturation across the lower area, and an average of a value across the lower area.

6. The apparatus of claim 1, wherein the processor circuitry is to process the upper area with automatic exposure and skip the lower area when the face mask is identified.

7. The apparatus of claim 1, wherein the processor circuitry is to process the upper area with automatic white balance and skip the lower area when the face mask is identified.

8. The apparatus of claim 1, wherein the processor circuitry is to:
identify a boundary line on the face of the person; and
divide the face into the upper area and the lower area based on the boundary line.

9. (canceled)

10. (canceled)

11. (canceled)

12. (canceled)

13. (canceled)

14. (canceled)

15. (canceled)

16. A non-transitory machine readable storage medium comprising instructions that, when executed, cause programmable circuitry to at least:
map a characteristic of an upper area of a face of a person in an image to a color plot including a face skin tone cone;
map a characteristic of a lower area of the face to the color plot; and
identify a presence or an absence of a face mask based on the respective positions of the characteristic of the upper area and the characteristic of the lower area relative to the face skin tone cone.

17. The storage medium of claim 16, wherein the instructions cause the programmable circuitry to determine a position of a boundary between the upper area and the lower area.

18. The storage medium of claim 16, wherein the instructions cause the programmable circuitry to:
convert RGB color space of pixels in the image into HSV color space; and
determine the characteristic of the upper area and the characteristic of the lower area based on the HSV color space.

19. The storage medium of claim 16, wherein the instructions cause the programmable circuitry to:
determine the characteristic of the upper area by aggregating an average hue, an average saturation, and an average value of a plurality of pixels in the upper area; and
determine the characteristic of the lower area by aggregating an average hue, an average saturation, and an average value of a plurality of pixels in the lower area.

20. The storage medium of claim 16, wherein the instructions cause the programmable circuitry to identify the presence of the face mask when the characteristic of the upper area is within the face skin tone cone and the characteristic of the lower area is not within the skin tone cone.

21. The storage medium of claim 16, wherein the instructions cause the programmable circuitry to identify the absence of the face mask when the characteristic of the upper area is not within the face skin tone cone.

22. The storage medium of claim 16, wherein the instructions cause the programmable circuitry to:
calculate a distance between the characteristic of the upper area and the characteristic of the lower area; and
verify the presence or the absence of the face mask based on the distance.

23. The storage medium of claim 22, wherein the instructions cause the programmable circuitry to:
compare the distance to a threshold distance; and
verify the presence of the face mask when the distance is greater than the threshold.

24. A method of processing images based on detection of a face mask, the method comprising:
identifying, by executing instructions with a processor, an upper area of a face and a lower area of a face;
calculating, by executing instructions with the processor:
an average hue (Hu), an average saturation (Su), and an average value (Vu) for the upper area;
an average hue (Hl), an average saturation (Sl), and an average value (Vl) for the lower area;
an HSV combination for the upper area: Pu (Hu, Su, Vu); and
an HSV combination for the lower area: Pl (Hl, Sl, Vl);
mapping, by executing instructions with the processor, the Pu and the Pl to a plot including a face skin tone cone; and
identifying, by executing instructions with the processor, a presence of an absence of the face mask based on a respective position of the Pu on the map and the Pl on the map relative to the face skin tone cone.

25. The method of claim 24, further including:
(1) identifying, by executing instructions with the processor, the presence of the face mask when the Pu is within the face skin tone cone and the Pl is not within the skin tone cone; or
(2) identifying, by executing instructions with the processor, the presence of the face mask when (a) the Pu is within the face skin tone cone, (b) the Pl is within the face skin tone cone, and (c) a calculated distance between one or more of the Hu, Su, Vu and one or more respective Hl, Sl, Vl is greater than a threshold distance.
